(19) United States
(12) Patent Application Publication
(10) Pub. No.: US 2022/0346021 A1
(43) Pub. Date: Oct. 27, 2022

(54) PSM and ANR Handling for Power Limited Devices

(71) Applicant: Telefonaktiebolaget LM Ericsson (publ), Stockholm (SE)

(72) Inventors: Ritesh Shreevastav, Upplands Väsby (SE); Antti Ratilainen, Espoo (FI); Hans Bertil Rönneke, Kungsbacka (SE)

(21) Appl. No.: 17/761,818

(22) PCT Filed: Sep. 30, 2020
(86) PCT No.: PCT/SE2020/050915

§ 371 Date: Mar. 18, 2022

Related U.S. Application Data
(60) Provisional application No. 62/909,644, filed on Oct. 2, 2019.

(51) Int. Cl. H04W 52/02; H04W 24/10

(52) U.S. Cl. CPC H04W 52/0274; H04W 24/10; H04W 52/0235

(57) ABSTRACT

Techniques are provided for a UE performing neighbor cell measurement prior to entry into a low power mode. Generally, the UE configures a low energy neighbor cell measurement. Responsive to a low power trigger, the UE delays transition to the low power mode to perform the neighbor cell measurement. The UE enters the low power mode after performing the neighbor cell measurement

### TECHNICAL FIELD

The present disclosure relates generally to power saving techniques for wireless devices in wireless communication networks and, more particularly, to Automatic Neighbor Relation (ANR) measurements in Narrowband Internet of Thongs (NB-IoT).

### BACKGROUND

In Long Term Evolution (LTE) and Wideband Code Division Multiple Access (WCDMA), ANR can identify new neighbor cells (nCells). Once the nCells are identified, the knowledge can be used to enable handovers, as well as for planning and optimization of Physical Cell Identities (PCI), Random Access Channel (RACH) configuration and interference coordination. Handovers may not be supported in NB-IoT. Radio access network (RAN) internal auto-configuration and optimization and inputs into a cell planner can be used for optimizing and troubleshooting various Evolved NodeB (eNB) parameters. Examples of parameters that can be auto-configured or optimized include:
eNB transmission (power, antenna location and tilt);
idle mode mobility (signal quality and strength thresholds);
NRS frequency reuse (PCID based); Narrowband Physical Broadcast Channel (NPBCH), Physical Downlink Shared Channel (PDSCH), System Information Block 1 (SIB1), Narrowband Primary Synchronization Signal (NPSS) and Narrowband Secondary Synchronization Signal (NSSS) intercell interference; and
Narrowband Physical Random Access Channel (NPRACH) detection and false alarm.

In LTE, a neighbor cell measurement, such as an ANR procedure, can be viewed as two step procedure: first, receiving an unknown PCI in measurement report from UE; and second, requesting the UE to read and report Channel Quality Indicator (CQI), Tracking Area Code (TAC), Public Land Mobile Networks (PLMNs) for specified PCI (PCI+SIB1).

Power saving mode (PSM) is a mode in which the UE is dormant, having paused most of its operations for a certain period of time. It can be initiated by the UE requesting with a non-access stratum (NAS) message an Activity Timer value, which defines the time when the network requires the UE to be active and reachable. If a network accepts PSM for the UE, it can confirm PSM by assigning an Active Timer value and/or another timer, such as a Tracking Area Update (TAU) timer value for the UE. When the Active Timer value expires, the network may assume the UE is in a PSM cycle and thus unreachable for the duration of the TAU value. After this, the UE may be assumed to be reachable again for the duration of Active Timer value, during which, for example, the timer values can be reconfigured.

Extended Discontinuous Reception (eDRX), also known as Extended Idle Mode Discontinuous Reception (DRX), is another technique for conserving power of a UE. eDRX is an extension of the idle mode discontinuous reception (DRX) to increase power saving compared to conventional DRX as applied in Universal Mobile Telecommunications Service (UMTS) Terrestrial Radio Access Network (UTRAN) and Evolved UTRAN (E-UTRAN).

ANR measurements are not currently supported in Narrowband Internet of Things (NB-IoT) networks. Performing ANR measurements and/or reporting as in Long Term Evolution (LTE) may cause unnecessary power consumption in the UE 120, which can be important in the case of NB-IoT UEs 120 with long intended battery life. Also, the existing idle mode measurements may cause issues or interfere with eDRX/PSM mechanisms, which may have negative impact on the UE battery consumption.

### SUMMARY

The present disclosure provides techniques for handling priority between low power modes and neighbor cell measurements. New neighbor cells can be identified by UEs without the network being aware that the UE is in an idle mode rather than a low power mode, thus ensuring that data can be collected in an efficient manner without interruptions.

A first aspect of the disclosure comprises methods implemented by a UE configured with a low power mode. In one embodiment of the method, the UE configures a neighbor cell measurement. Responsive to a low power trigger, the UE delays transition to the low power mode to perform the neighbor cell measurement. The UE enters the low power mode after performing the neighbor cell measurement.

A second aspect of the disclosure comprises a UE configured with a low power mode. The UE is configured to configure a neighbor cell measurement. Responsive to a low power trigger, the UE is configured to delay transition to the low power mode to perform the neighbor cell measurement. The UE is configured to enter the low power mode after performing the neighbor cell measurement.

A third aspect of the disclosure comprises methods implemented by a UE configured with a low power mode. In one embodiment, the UE postpones a request for a low power mode when a neighbor cell measurement is pending. The UE performs the neighbor cell measurement when entering an idle mode. The UE sends the request when returning to a connected mode.

A fourth aspect of the disclosure comprises a UE configured with a low power mode. The UE is configured to postpone a request for a low power mode when a neighbor cell measurement is pending. The UE is configured to perform the neighbor cell measurement when entering an idle mode. The UE is configured to send the request when returning to a connected mode.

A fifth aspect of the disclosure comprises a computer program product comprising executable instructions that configure a processing circuit in a UE to perform the method according to the first or third aspects. The computer program product can be embodied in a carrier, such as an electronic signal, optical signal, radio signal, or computer readable storage medium.

### BRIEF DESCRIPTION OF THE DRAWINGS

FIG. 1 illustrates an exemplary communication network according to an embodiment.

FIG. 2 illustrates a method implemented by a UE.

FIG. 3 illustrates a method implemented by a UE.

FIG. 4 is a schematic block diagram of an exemplary UE.

FIG. 5 is a schematic block diagram of an exemplary UE.

FIG. 6 is a functional block diagram of a wireless terminal that can be configured as a UE or base station.

FIG. 7 is a schematic block diagram illustrating an example wireless network, according to particular embodiments of the present disclosure.

FIG. 8 is a schematic block diagram illustrating an example of a user equipment, according to particular embodiments of the present disclosure.

FIG. 9 is a schematic block diagram illustrating an example of a virtualization environment, according to particular embodiments of the present disclosure.

FIG. 10 is a schematic illustrating an example telecommunication network, according to particular embodiments of the present disclosure.

FIG. 11 is a schematic block diagram illustrating an example communication system, according to particular embodiments of the present disclosure.

FIGS. 12-15 are flow diagrams, each of which illustrates an example method implemented in a communication system, according to particular embodiments of the present disclosure.

### DETAILED DESCRIPTION

Referring now to the drawings, an exemplary embodiment of the disclosure will be described in the context of a NB-IoT wireless communication network. Those skilled in the art will appreciate that the methods and apparatus herein described are not limited to use in NB-IoT networks, but may also be used in wireless communication networks 10 where multiple beams within a single cell are used for communication with wireless devices in the cell.

Power saving is important in NB-IoT networks because of the nature of the devices in the networks. For instance, NB-IoT devices are typically sensors that transmit and receive only small amounts of data infrequently. They remain in the field for long periods of time with few opportunities to recharge. Therefore reduced power consumption provides a great advantage in such networks.

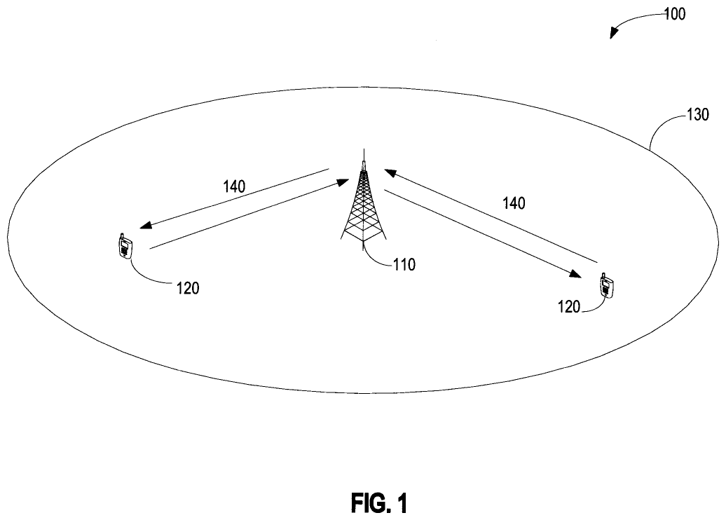

FIG. 1 illustrates a wireless communication network 100 according to the New Radio (NR) standard currently being developed by Third Generation Partnership Project (3GPP). The wireless communication network 100 comprises one or more base stations 110 providing service to user equipment (UEs) 120 in respective cells 130 of the wireless communication network 100. The base stations 110 are also referred to as Evolved NodesBs (eNBs) and gNodeBs (gNBs) in 3GPP standards. Although only one cell 130 and one base station 110 are shown in FIG. 1, those skilled in the art will appreciate that a typical wireless communication network 100 comprises many cells 130 served by many base stations 110.

The UEs 120 may comprise any type of equipment capable of communicating with the base station 110 over a wireless communication channel. For example, the UEs 120 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 100.

Power saving mode (PSM) is a mode in which the UE 120 is dormant, having paused most of its operations for a certain period of time. It can be initiated by the UE 120 requesting with a non-access stratum (NAS) message an Activity Timer value, which defines the time when the network requires the UE 120 to be active and reachable. If a network accepts PSM for the UE 120, it can confirm PSM by assigning an Active Timer value and/or another timer, such as a Tracking Area Update (TAU) timer value for the UE 120. When the Active Timer value expires, the network may assume the UE 120 is in PSM cycle and thus unreachable for the duration of the TAU value. After this, the UE 120 may be assumed to be reachable again for the duration of Active Timer value, during which, for example, the timer values can be reconfigured.

A UE 120 may adopt a PSM that is described in TS 23.682. If a UE 120 can adopt a PSM and wants to use the PSM, it can request an Active Timer value and a periodic TAU or Routing Area Update (RAU) timer value during every Attach and TAU procedures. The UE 120 may not request a Periodic TAU/RAU Timer value if it is not requesting an Active Timer value. The network may not allocate an Active Timer value if the UE 120 has not requested it.

Another power saving technique is eDRX. eDRX is an extension of the DRX in E-UTRAN and UTRAN. 3GPP TS 23.682 provides the extended idle mode DRX value range. Likewise, 3GPP TS 23.682 describes a way that the UE 120 and the core network may negotiate the use of extended idle mode DRX. The Mobility Management Entity (MME) can include the extended idle mode DRX cycle length in a paging message to assist the eNB in paging the UE 120.

For an extended idle mode DRX cycle length of 10.24 s or longer, the UE 120 may take various actions. If the UE 120 decides to request for extended idle mode DRX, the UE 120 can include an extended idle mode DRX parameters information element in the attach request and/or TAU request message. The UE 120 can also include the UE 120 specific DRX parameters for regular idle mode DRX. The extended idle mode DRX parameters information element can include the idle mode DRX length.

In an eDRX cycle length of 10.24 s or longer, the MME can decide whether to accept or reject the UE request for enabling extended idle mode DRX. Depending on whether the MME accepts the extended idle mode DRX, the MME may also provide different values of the extended idle mode DRX parameters than what was requested by the UE 120. This MME provisioning can be based on operator policies and, if available, the extended idle mode DRX cycle length value in the subscription data from the HSS. While taking into account the Radio Access Technology (RAT)-specific Subscribed Paging Time Window, the UE's current RAT (NB-IoT or Wideband E-UTRAN (WB-E-UTRAN)), and local policy, the MME can also assign a Paging Time Window length to be used and can provide this value to the UE 120 during Attach/TAU procedures together with the extended idle mode DRX cycle length in the extended idle mode DRX parameter. If the MME accepts the use of extended idle mode DRX, the UE 120 can apply extended idle mode DRX based on the received extended idle mode DRX length, the UE's current RAT (NB-IoT or WB-E-UTRAN) and RAT specific Paging Time Window length. If the UE 120 does not receive the extended idle mode DRX parameters information element in the relevant accept message because the MME (or Serving GPRS (General Packet Radio Services) Support Node (SGSN)) rejected its request, or because the request was received by SGSN/MME not supporting extended idle mode DRX, the UE 120 can apply its regular DRX. The UE 120 can include the extended idle mode DRX parameters information element in each TAU message if it still wants to use extended idle mode DRX. If eDRX is enabled, the MME can handle paging.

ANR measurements and reporting is not currently supported by NB-IoT, and thus it needs to be specified how such procedures are performed. The NB-IoT UE 120 can perform idle mode measurements for ANR. Performing the measurements and/or reporting as in legacy LTE may cause unnecessary power consumption in the UE 120, which can be important in the case of NB-IoT UEs 120 with long intended battery life. Also, the existing idle mode measurements may cause issues or interfere with eDRX/PSM mechanisms, which may have negative impact on the UE battery consumption.

As part of ANR, the UE 120 can identify the CQI of the strong cell. Performing CQI measurements can require the UE 120 to read the Master Information (MIB) and System Information Block (SIB) of another cell (detected strong cell), which can be power consuming.

PSM can be configured by NAS, whereas ANR measurement can be configured for a group of UEs 120 in a cell 130 by the base station (e.g. eNB) 110. NAS can also configure PSM, and access stratum (AS) can configure ANR to the same UE 120. Relaxed monitoring and cell reselection rules may not apply when the UE 120 is configured to measure ANR and until ANR measurement is completed.

PSM is a NAS (i.e., core network) feature. When NAS indicates that PSM starts, the AS configuration (e.g., priorities provided by dedicated signaling and logged measurements) can be maintained, all running timers continue to run but the UE 120 need not perform any idle mode tasks. In the above examples, the UE 120 can perform the ANR measurement in idle mode, in such case there can be conflict with ANR and PSM.

Embodiments described within allow NB-IoT devices to ensure that ANR can be performed and prioritized for low power devices, that the UE 120 can re-enter PSM mode if interrupted by ANR, and that the UE 120 can re-enter eDRX mode if interrupted by ANR.

A UE 120 can handle the priority between PSM and ANR and between eDRX and ANR in various ways. For example, a condition/state can be defined in a UE 120 that keeps track of the need to trigger PSM and further if any request from the network on ANR measurements. Further, a condition/state can be defined in the UE 120 which keeps track of the need to trigger eDRX and further if any request from the network on ANR measurements. A priority mechanism is defined for the case where a UE 120 configured for ANR receives commands from the network, i.e., a PSM is granted by the core network. Further, a method is provided to handle the PSM trigger (PSM Active Request from UE 120) if there is a pending ANR measurement to be performed. Likewise, a method is provided to handle the eDRX trigger (eDRX Cycle Length request from UE 120) if there is a pending ANR measurement to be performed.

In some embodiments, if a UE 120 is configured simultaneously with PSM or eDRX from NAS and ANR from Radio Resource Control (RRC)/eNB, the UE 120 can delay entering the PSM or eDRX respectively. This delay can be approximately the duration required to perform ANR measurements. From a core network perspective, however, the UE 120 may act as if it has already entered the PSM or eDRX. Thus, the UE 120 may not perform a second request or switch between idle mode (RRC_IDLE) to connected mode (RRC_CONNECTED) multiple times in order to obtain the PSM or eDRX. The UE 120 can log the ANR measurement report and then enter the PSM or eDRX.

The UE 120 can be configured with PSM or eDRX by NAS and ANR by RRC/eNB in connected mode. If the UE 120 enters idle mode, the network can assume that the UE 120 follows PSM procedure, entering PSM cycle if the Active Timer expires. Similarly, in the case of eDRX, the UE 120 can enter eDRX dormant mode at idle mode entry. During the PSM cycle and eDRX cycle, the network can assume the UE 120 to be unreachable.

On the UE 120 side, when entering idle mode and the Active Timer of the PSM expires, or when entering idle mode and the eDRX has been negotiated, the UE 120 can first perform its configured ANR measurements as specified before entering a PSM cycle or eDRX cycle. If the UE 120 has performed and stored its assigned ANR measurements as specified, it can follow with the PSM procedure or eDRX procedure, turning off all non-critical functionality and entering PSM/eDRX cycle for the rest of the PSM/eDRX cycle duration. When the UE 120 wakes up from the PSM/eDRX cycle, it can indicate to the network it has available ANR measurement results.

In some embodiments, the UE 120 may not request PSM active time or eDRX cycle length if it has any pending or ongoing ANR measurements. If configured with ANR measurements, the UE 120 can follow the specified procedures for ANR measurements when entering RRC_IDLE, and after that, if returning to RRC_CONNECTED, the UE 120 can request to activate PSM during the PSM active time or to activate eDRX during the eDRX cycle length.

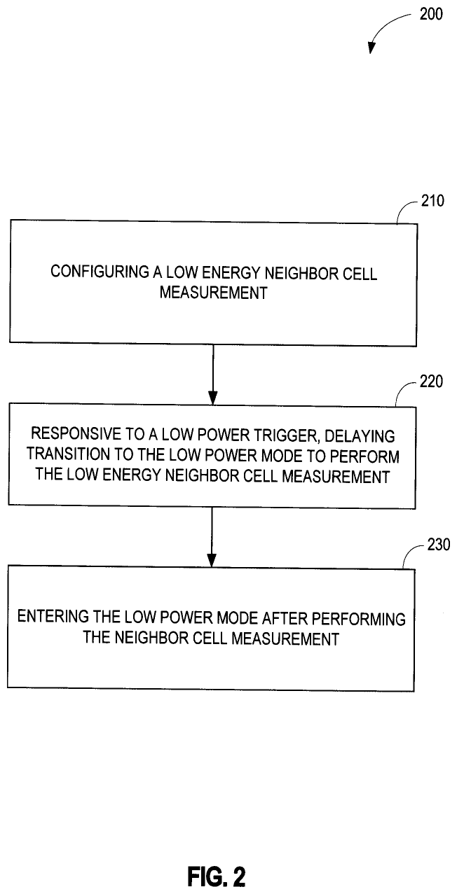

FIG. 2 illustrates an exemplary method 200 performed by a UE 120 according to an embodiment. The method comprises configuring, by the UE 120, a neighbor cell measurement (210). The neighbor cell measurement may comprise a low energy neighbor cell measurement. The method further comprises delaying, by the UE 120 and responsive to a low power trigger, transition to the low power mode to perform the neighbor cell measurement (220). The UE 120 then enters the low power mode after performing the neighbor cell measurement (230).

Some embodiments of the method 200 further comprises receiving a configuration for the neighbor cell measurement from a network node.

Some embodiments of the method 200 further comprise receiving a configuration for low power mode from a core network.

Some embodiments of the method 200 further comprise storing the neighbor cell measurement while in the low power mode.

Some embodiments of the method 200 further comprise transmitting a notification that the neighbor cell measurement is available when the UE is no longer in the low power mode.

Some embodiments of the method 200 further comprise transmitting the neighbor cell measurement when the UE is no longer in the low power mode.

In some embodiments of the method 200, the low power mode is a PSM configuration.

In some embodiments of the method, the trigger is an expiration of an active timer.

In some embodiments of the method 200, the low power mode is idle mode where measurements are performed using discontinuous reception (DRX) configuration or extended discontinuous reception (eDRX) configuration.

In some embodiments of the method 200, delaying transition to the low power comprises at one of inhibiting sending a request for PSM grant to the core network node or delaying entering PSM mode if the PSM grant has been received.

In some embodiments of the method 200, the neighbor cell measurement comprises at least one of a strong cell detection, channel quality indication (CQI), Reference Signal Received Power (RSRP), Cell Global Identifier (CGI), Tracking Area Code (TAC), and/or Public Land Mobile Networks (PLMNs).

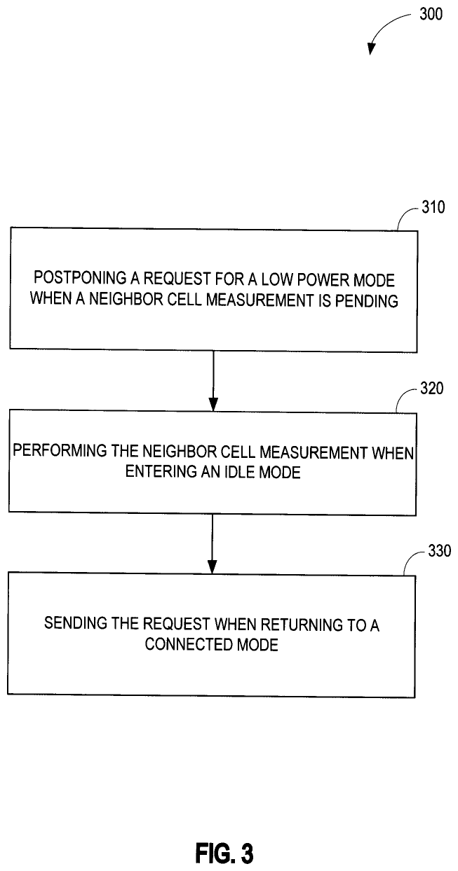

FIG. 3 illustrates an exemplary method 300 performed by a UE 120. The method postpones a request for a low power mode when a neighbor cell measurement is pending (310). The method then performs the neighbor cell measurement when entering an idle mode (320). The method sends the request when returning to a connected mode (330).

Some embodiments of the method 300 further comprise receiving a configuration for the neighbor cell measurement from a network node.

Some embodiments of the method 300 further comprise receiving a configuration for low power mode from a core network.

The method can further comprise storing the neighbor cell measurement while in the low power mode.

Some embodiments of the method 300 further comprise transmitting a notification that the neighbor cell measurement is available when the UE returns to connected mode. The method can further comprise transmitting the neighbor cell measurement when the UE returns to connected mode. In some embodiments, the low power mode is a PSM configuration.

In some embodiments of the method 300, the request is a request for an active timer value.

In some embodiments of the method 300, the low power mode is an eDRX configuration.

In some embodiments of the method 300, the request is a request to enable eDRX.

In some embodiments of the method 300, the neighbor cell measurement comprises at least one of CQI, TAC, and/or PLMNs.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

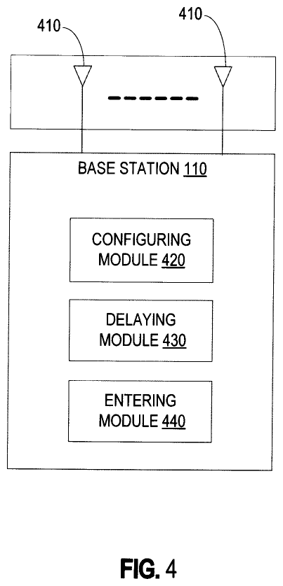

FIG. 4 illustrates a UE 120 in accordance with one or more embodiments. The UE 120 comprises one or more antennas 415, a first module 420, a second module 430 and a third module 440. The various modules 420, 430, and 440 can be implemented by hardware and/or by software code that is executed by one or more processors or processing circuits. The configuring module 420 is configured to configure a low energy neighbor cell measurement. The delaying module 430 is configured to send measurement reports according to delay transition to the low power mode to perform the neighbor cell measurement responsive to a low power trigger. The entering module 440 is configured to enter the low power mode after performing the neighbor cell measurement.

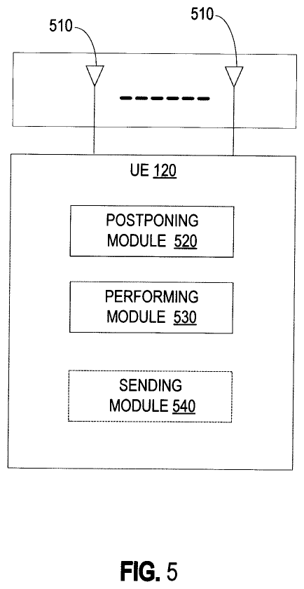

FIG. 5 illustrates a UE 120 in accordance with one or more embodiments. The base station 510 comprises on or more antennas 510, a first module 520, a second module 530, and a third module 540. The various modules 520, 530, and 540 can be implemented by hardware and/or by software code that is executed by a processor or processing circuit. The postponing module 520 is configured to postpone a request for a low power mode when a neighbor cell measurement is pending. The performing module 530 is configured to perform the neighbor cell measurement when entering an idle mode. The sending module 540 is configured to sending the request when returning to a connected mode. The sending module 540 is shown as optional because the antenna 532 or an interface can also perform the tasks of the sending module.

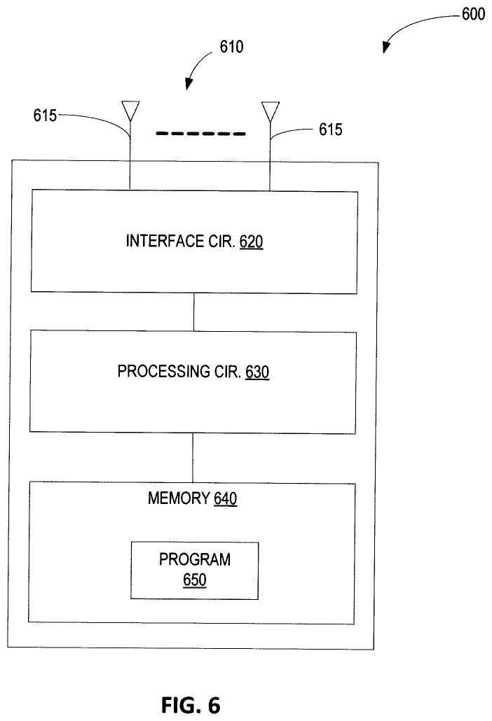

FIG. 6 illustrates a radio node 600 according to one embodiment that may be configured to function as a UE 120 as herein described. The radio node 600 comprises an antenna array 610 with multiple antenna elements 615, an interface circuit 620, a processing circuit 630, and memory 640.

The interface circuit 620 is coupled to the antennas 615 and comprises the radio frequency (RF) circuitry needed for transmitting and receiving signals over a wireless communication channel. The processing circuit 630 controls the overall operation of the radio node 600 and processes the signals transmitted to or received by the radio node 600. Such processing includes coding and modulation of transmitted data signals, and the demodulation and decoding of received data signals. The processing circuit 630 may comprise one or more microprocessors, hardware, firmware, or a combination thereof.

Memory 640 comprises both volatile and non-volatile memory for storing computer program code and data needed by the processing circuit 630 for operation. Memory 640 may comprise any tangible, non-transitory computer-readable storage medium for storing data including electronic, magnetic, optical, electromagnetic, or semiconductor data storage. Memory 640 stores a computer program 650 comprising executable instructions that configure the processing circuit 630 to implement the methods 200 or 300 according to FIGS. 2 and 3 as described herein. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 650 for configuring the processing circuit 630 as herein described may be stored in a removable memory, such as a portable compact disc, portable digital video disc, or other removable media. The computer program 650 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

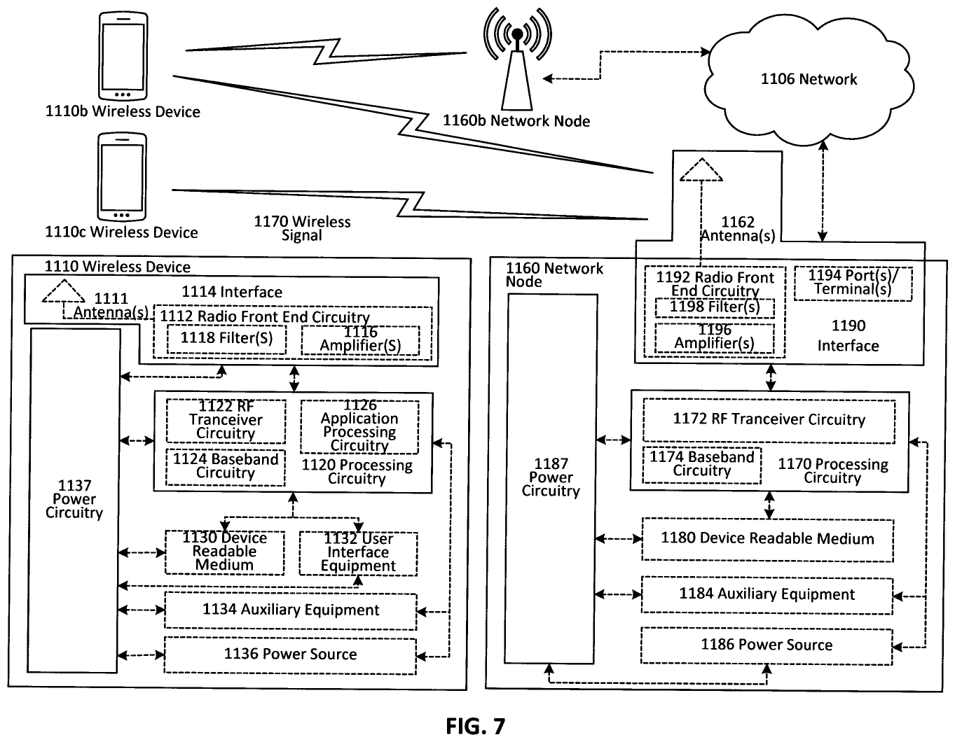

Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 7 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 7 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

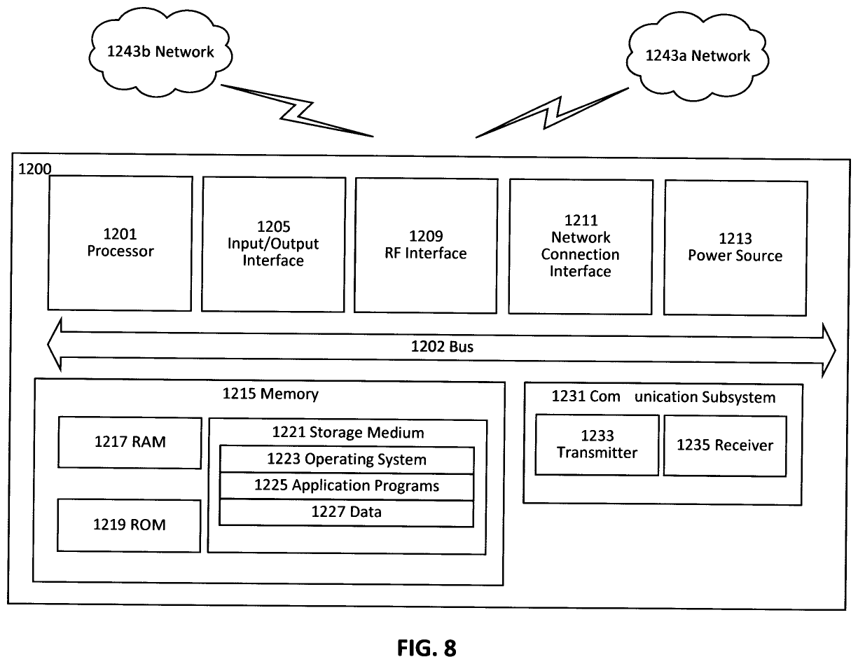

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 8, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 8 is a UE, the components discussed herein are equally applicable to a WD, and vice-versa.

In FIG. 8, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 8, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.8, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

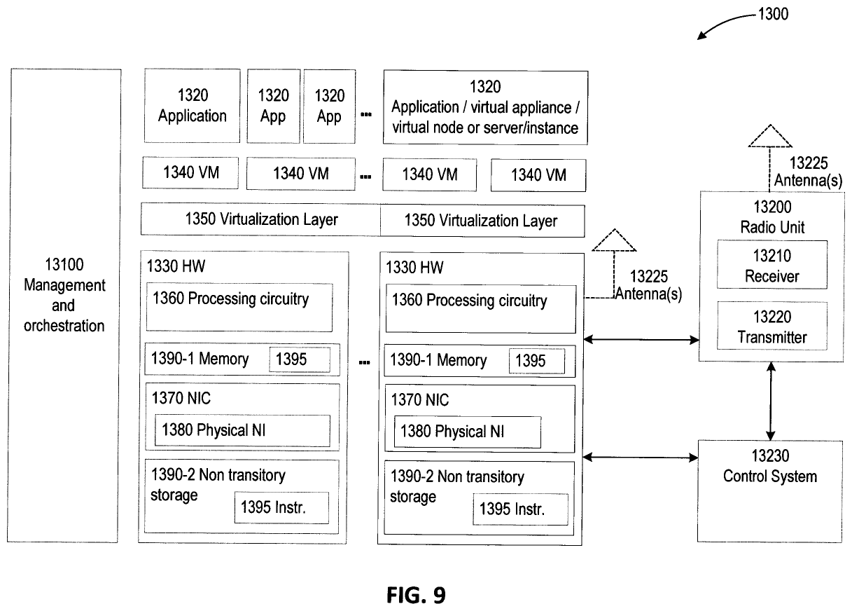

FIG. 9 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 9, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 9.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

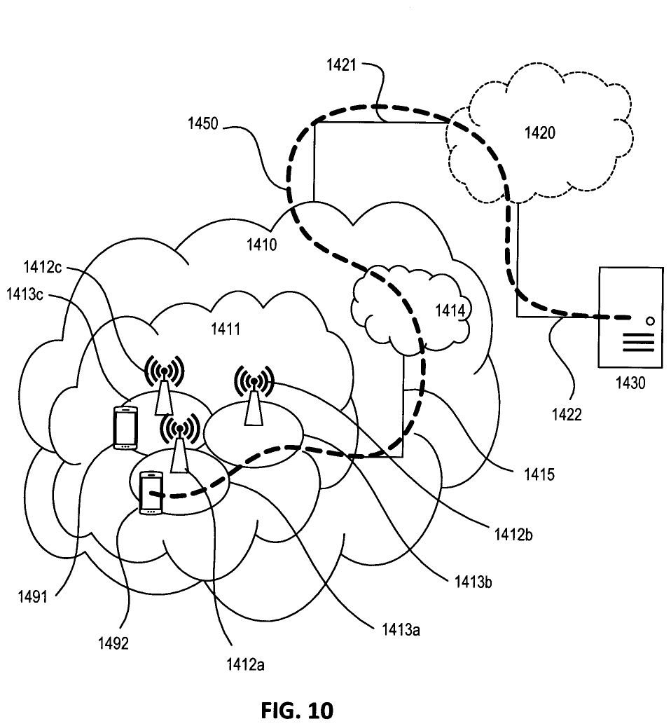

FIG. 10 illustrates a telecommunication network connected via an intermediate network to a host computer in accordance with some embodiments. In particular, with reference to FIG. 10, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 10 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

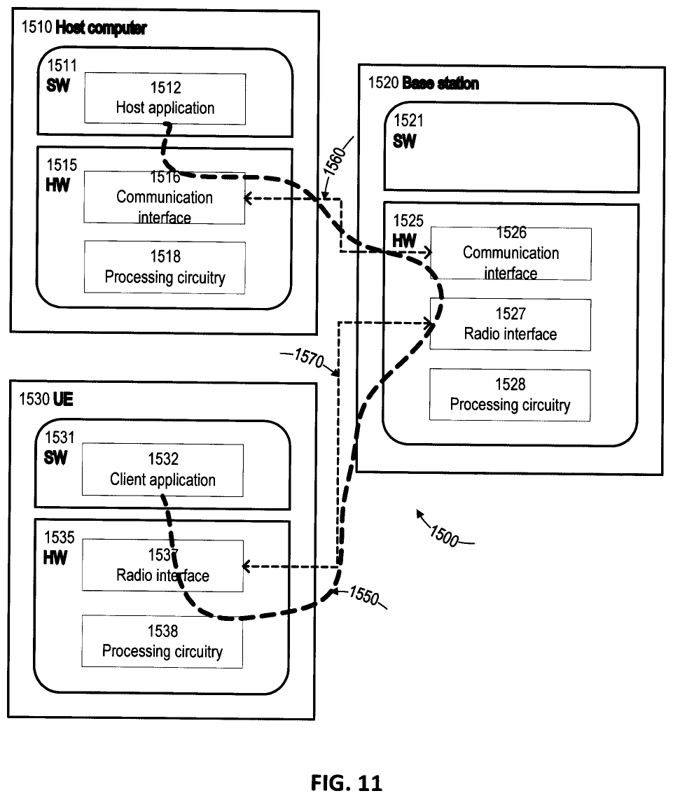

Example implementations, in accordance with an embodiment, of the UE, base station and host computer discussed in the preceding paragraphs will now be described with reference to FIG. 11. FIG. 11 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 11) served by base station 1520. Communication interface 1526 may be configured to facilitate connection 1560 to host computer 1510. Connection 1560 may be direct or it may pass through a core network (not shown in FIG. 11) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 11 may be similar or identical to host computer 1430, one of base stations 1412a, 1412b, 1412c and one of UEs 1491, 1492 of FIG. 10, respectively. This is to say, the inner workings of these entities may be as shown in FIG. 11 and independently, the surrounding network topology may be that of FIG. 10.

In FIG. 11, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the power consumption and thereby provide benefits such as extended battery lifetime.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

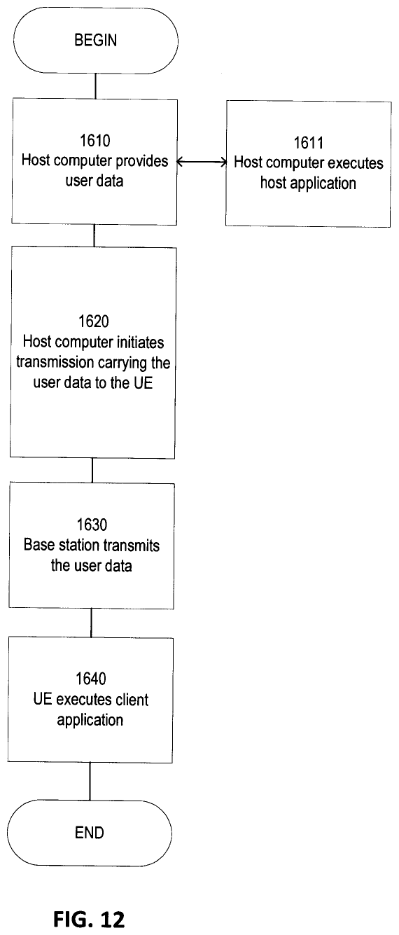

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

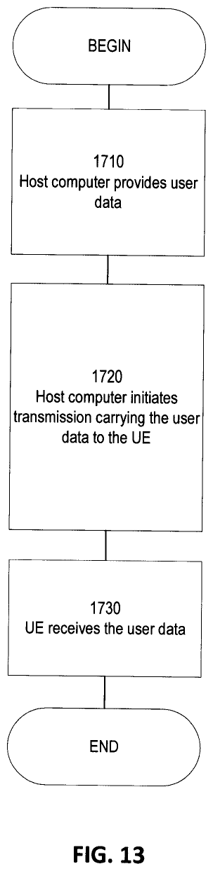

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

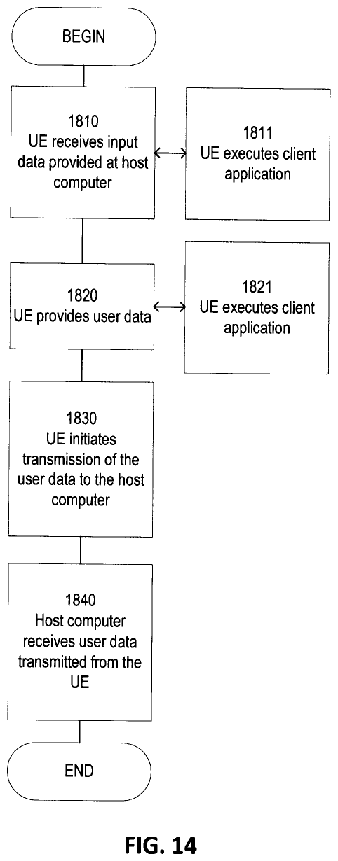

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

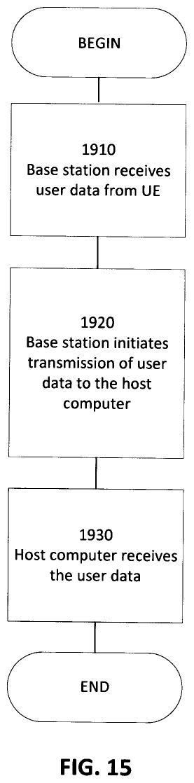

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Additional information may be found in Appendix A, which is incorporated in its entirety by reference.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

### 1×RTT CDMA2000 1× Radio Transmission Technology

### 3GPP 3rd Generation Partnership Project

### 5G 5th Generation

### ABS Almost Blank Subframe

### ARQ Automatic Repeat Request

### AWGN Additive White Gaussian Noise

### BCCH Broadcast Control Channel

### BCH Broadcast Channel

### CA Carrier Aggregation

### CC Carrier Component

### CCCH SDU Common Control Channel SDU

### CDMA Code Division Multiplexing Access

### CGI Cell Global Identifier

### CIR Channel Impulse Response

### CP Cyclic Prefix

### CPICH Common Pilot Channel

CPICH Ec/No CPICH Received energy per chip divided by the power density in the band
CQI Channel Quality information

### C-RNTI Cell RNTI

### CSI Channel State Information

### DCCH Dedicated Control Channel

### DL Downlink

### DM Demodulation

### DMRS Demodulation Reference Signal

### DRX Discontinuous Reception

### DTX Discontinuous Transmission

### DTCH Dedicated Traffic Channel

### DUT Device Under Test

E-CID Enhanced Cell-ID (positioning method)

### E-SMLC Evolved-Serving Mobile Location Centre

### ECGI Evolved CGI

### eNB E-UTRAN NodeB

ePDCCH enhanced Physical Downlink Control Channel
E-SMLC evolved Serving Mobile Location Center

### E-UTRA Evolved UTRA

### E-UTRAN Evolved UTRAN

### FDD Frequency Division Duplex

### FFS For Further Study

### GERAN GSM EDGE Radio Access Network

gNB Base station in NR

### GNSS Global Navigation Satellite System

GSM Global System for Mobile communication

### HARQ Hybrid Automatic Repeat Request

### HO Handover

### HSPA High Speed Packet Access

### HRPD High Rate Packet Data

### LOS Line of Sight

### LPP LTE Positioning Protocol

### LTE Long-Term Evolution

### MAC Medium Access Control

### MBMS Multimedia Broadcast Multicast Services

MBSFN Multimedia Broadcast multicast service Single Frequency Network

### MBSFN ABS MBSFN Almost Blank Subframe

### MDT Minimization of Drive Tests

### MIB Master Information Block

### MME Mobility Management Entity

### MSC Mobile Switching Center

### NAS Non-Access Stratum

### NPDCCH Narrowband Physical Downlink Control Channel

### NR New Radio

### OCNG OFDMA Channel Noise Generator

### OFDM Orthogonal Frequency Division Multiplexing

### OFDMA Orthogonal Frequency Division Multiple Access

### OSS Operations Support System

### OTDOA Observed Time Difference of Arrival

### O&M Operation and Maintenance

### PBCH Physical Broadcast Channel

### P-CCPCH Primary Common Control Physical Channel

### PCell Primary Cell

### PCFICH Physical Control Format Indicator Channel

### PDCCH Physical Downlink Control Channel

### PDP Profile Delay Profile

### PDSCH Physical Downlink Shared Channel

### PGW Packet Gateway

### PHICH Physical Hybrid-ARQ Indicator Channel

### PLMN Public Land Mobile Network

### PMI Precoder Matrix Indicator

### PRACH Physical Random Access Channel

### PRS Positioning Reference Signal

### PSS Primary Synchronization Signal

### PUCCH Physical Uplink Control Channel

### PUSCH Physical Uplink Shared Channel

### RACH Random Access Channel

### QAM Quadrature Amplitude Modulation

### RAN Radio Access Network

### RAT Radio Access Technology

### RLM Radio Link Management

### RNC Radio Network Controller

### RNTI Radio Network Temporary Identifier

### RRC Radio Resource Control

### RRM Radio Resource Management

### RS Reference Signal

### RSCP Received Signal Code Power

### RSRP Reference Symbol Received Power OR

Reference Signal Received Power

### RSRQ Reference Signal Received Quality OR

Reference Symbol Received Quality

### RSSI Received Signal Strength Indicator

### RSTD Reference Signal Time Difference

### SCH Synchronization Channel

### SCell Secondary Cell

### SDU Service Data Unit

### SFN System Frame Number

### SGW Serving Gateway

### SI System Information

### SIB System Information Block

### SNR Signal to Noise Ratio

### SON Self Optimized Network

### SS Synchronization Signal

### SSS Secondary Synchronization Signal

### TAC Type Allocation Code

### TAU Tracking Area Update

### TDD Time Division Duplex

### TDOA Time Difference of Arrival

### TOA Time of Arrival

### TSS Tertiary Synchronization Signal

### TTI Transmission Time Interval

### UE User Equipment

### UL Uplink

### UMTS Universal Mobile Telecommunication System

### USIM Universal Subscriber Identity Module

### UTDOA Uplink Time Difference of Arrival

### UTRA Universal Terrestrial Radio Access

### UTRAN Universal Terrestrial Radio Access Network

### WCDMA Wide CDMA

### WLAN Wide Local Area Network

1-19. (canceled)

20. A method implemented by a user equipment (UE) configured with a low power mode, the method comprising the UE:
receiving a configuration for a neighbor cell measurement from a network node;
delaying, responsive to a low power trigger, transition to the low power mode to perform the neighbor cell measurement; and
entering the low power mode after performing the neighbor cell measurement.

21. The method of claim 20, further comprising receiving a configuration for low power mode from a core network.

22. The method of claim 20, further comprising storing the neighbor cell measurement while in the low power mode.

23. The method of claim 22, further comprising transmitting a notification that the neighbor cell measurement is available when the UE is no longer in the low power mode.

24. The method of claim 22, further comprising transmitting the neighbor cell measurement when the UE is no longer in the low power mode.

25. The method of claim 20, wherein the low power mode is a Power Saving Mode (PSM) configuration.

26. The method of claim 25, wherein the trigger is an expiration of an active timer.

27. The method of claim 20, wherein the low power mode is idle mode where measurements are performed using discontinuous reception configuration or extended discontinuous reception configuration.

28. The method of claim 20, wherein the delaying transition to the low power comprises:
inhibiting sending a request for Power Saving Mode (PSM) grant to the core network node; and/or
delaying entering PSM mode if the PSM grant has been received.

29. The method of claim 20, wherein the neighbor cell measurement comprises: a strong cell detection, a channel quality indication, a Reference Signal Received Power, a Cell Global Identifier, a Tracking Area Code, and/or a Public Land Mobile Networks (PLMNs).

30. A user equipment in a wireless communication network, the user equipment comprising:
interface circuitry configured for communication with one or more serving cells the wireless communication network; and
processing circuitry configured to cause the user equipment to:
receive a configuration for a neighbor cell measurement from a network node;
delay, responsive to a low power trigger, transition to the low power mode to perform the neighbor cell measurement; and
enter the low power mode after performing the neighbor cell measurement.

31. The user equipment of claim 30, wherein the processing circuitry is configured to cause the user equipment to receive a configuration for low power mode from a core network.

32. The user equipment of claim 30, wherein the processing circuitry is configured to cause the user equipment to store the neighbor cell measurement while in the low power mode.

33. The user equipment of claim 32, wherein the processing circuitry is configured to cause the user equipment to transmit a notification that the neighbor cell measurement is available when the UE is no longer in the low power mode.

34. The user equipment of claim 32, wherein the processing circuitry is configured to cause the user equipment to transmit the neighbor cell measurement when the UE is no longer in the low power mode.

35. The user equipment of claim 30, wherein the low power mode is a Power Saving Mode (PSM) configuration.

36. The user equipment of claim 35, wherein the trigger is an expiration of an active timer.

37. The user equipment of claim 30, wherein the low power mode is idle mode where measurements are performed using discontinuous reception configuration or extended discontinuous reception configuration.

38. The user equipment of claim 30, wherein the processing circuitry is configured to cause the user equipment to delay transition to the low power by:
inhibiting sending a request for Power Saving Mode (PSM) grant to the core network node; and/or
delaying entering PSM mode if the PSM grant has been received.

39. A non-transitory computer readable recording medium storing a computer program product for controlling a user equipment (UE), the computer program product comprising program instructions which, when run on processing circuitry of the UE entity, causes the UE to:
receive a configuration for a neighbor cell measurement from a network node;
delay, responsive to a low power trigger, transition to the low power mode to perform the neighbor cell measurement; and
enter the low power mode after performing the neighbor cell measurement.
